(19) United States
(12) Patent Application Publication
(10) Pub. No.: US 2015/0354743 A1
(43) Pub. Date: Dec. 10, 2015

(54) ARRANGEMENT AND METHOD FOR LINING PIPES

(71) Applicant: Olimb Group AS, Rade (NO)

(72) Inventor: Rolf DALBY, Engelsvik (NO)

(73) Assignee: Olimb Group AS, Rade (NO)

(21) Appl. No.: 14/487,585

(22) Filed: Sep. 16, 2014

(30) Foreign Application Priority Data
Jun. 6, 2014 (GB) GB1410508.4

(51) Int. Cl. F16L 55/165

(52) U.S. Cl. CPC F16L 55/1651

(57) ABSTRACT

The invention relates to lining of pipes, whereby a liner (1) is everted into the pipe (7). To facilitate lining through a multiple off bends, the invention suggests using a hooked band (4), such as Velcro®, which attaches to the flossy side (2) of the liner (1). The hooked band (4) attach to the liner (1) along the whole length where it is in contact with the flossy felt (2). Consequently, when a pull is exerted on the band (4), the force attack the leading end (14) of the liner, i.e. the end that has progressed furthest into the pipe (7), where the pull is needed.

As the liner (1) is everted, the flossy felt (2) will be pulled away from the band (4) and thus the point of attack of the pull force will move along the liner (1) as it is being everted.

The present invention relates to an arrangement and a method for lining pipes, as well as a liner for pipes.

Lining of pipes is a viable method to perform repair of all types of pipelines, such as water pipes, sewage pipes or gas and oil pipes, if the pipe is leaking or there is a risk of leakage. Often the leaks are small, but many. In these cases the pipe may have sufficient structural strength remaining so that if the leaks are reaped, the pipe may still have many years of service left.

It is known in the art to line pipes using a flexible liner, which is everted into the pipe to be lined. Everting (sometimes also called inverting) is a method by which the liner is turned inside out while it is inserted into the pipe. Such a method is shown in principle e.g. in EP 691507 and U.S. Pat. No. 6,701,966.

The liners are generally flossy, due to a felt material, on one side and has an impermeable coating on the other side. The flossy inside is soaked in a resinous substance before the inserting into the pipe. At the start of the everting, the flossy side is turned inward of the liner. The trailing end of the liner is closed by a cord or similar. The leading edge of the liner is everted and attached to a pressurizing device. Thereafter, the liner is pressurized and starts to crawl into the pipe by being turned inside out.

As the everting progresses, the flossy inside with the resinous substance will be everted outwards so that it faces the inside of the pipe. The resinous substance will attach to the inside of the pipe and cure. The curing may be a self-curing over time, but may also be initiated by using hot air, steam or hot water inside the liner. When the closed off end of the liner reaches the distal end of the pipe section to be lined, the end is opened. Now the lining of this section of pipe is finished.

In these methods air pressure, or the pressure of another fluid, is used to turn the liner inside out while it propagates into the pipe. This method works fine when the stretch of pipe to be lined is not too long and does not have too many bends. However, if the pipe has a lot of bends, the stretch along which the liner will be inserted as a continuous piece, has to be shortened. Hence, instead of inserting a long continuous liner, in one smooth operation, the liner has to be inserted in several sections. For each section, the pipe has to be exposed. This often involves digging into the ground where the pipe is buried. The digging may have to be done in the middle of a street and in the cellar of buildings. This is costly and often disrupts normal business. Moreover, the lining of the pipe takes considerably longer time and will become costly.

An attempt has been made to use a pull rope attached to the trailing end of the liner. The idea is that the rope will guide the liner through the bends. However, if the pull rope is pulled too hard, the liner will pile up or crease near the end where the rope has been fixed. If this happens, the liner may get stuck. A higher pressure applied inside the liner, may cause it to rupture. If this happens, it may be necessary to expose the pipe at the location of the rupture, wherever that may be.

It is therefore a need for a more secure method for inserting the liner into the pipe. It is therefore an object of the present invention to provide a liner arrangement and a method for lining that ensures that a liner can be everted through a multiple of bends and over long stretches, without the risks of getting stuck that hampers the known techniques.

The solution is to use a pull rope comprising a hooked band, such as Velcro®, that attaches to the flossy side of the liner. The hooked band will attach to the liner along the whole length where it is on contact with the flossy felt. This means that when a pull is exerted on the band, the force will attack the leading end of the liner, i.e. the end that has progressed furthest into the pipe. Consequently, the pull will be where it is needed. As the liner is everted, the flossy felt will be pulled away from the band and thus the point of attack of the pull force will move along the liner as it is being everted. The point of attack will always be at the end of the liner furthest into the pipe.

In a first aspect the invention relates to an arrangement for inserting a liner into a pipe, comprising a liner having a first side that is at least partly flossy, said liner being adapted to be everted into the pipe, so that the flossy side is turned from being inside the liner to become the outside of the liner as the liner propagates along the inside of the pipe. The invention is characterized in that it comprises a pull band having hooks on at least one side of said band, said hooks being adapted to attach to said flossy side of said liner.

Preferably, the pull band extends along substantially the whole length of the liner, and the pull band has hooks along substantially the whole length. This ensures that the pull band can be used to pull or guide the liner through the whole stretch of pipe to be lined.

In a further preferred embodiment, the pull band comprises hooks on two side surfaces of said band. Thereby, the liner will be pulled evenly through the pipe, and it is ensured that the pull band will steer the liner through bends of all directions.

Further preferred, a pull rope is attached to a leading end of said band. This pull rope may be blown through the pipe. The pull rope reduces the necessary length of pull band.

In a second aspect the invention relates to a method for inserting a liner into a pipe, said liner having a first side that is at least partially flossy, comprising:

turning a first end portion of said liner inside out,

fixating the end of said first end portion,

entering said first end portion into said pipe,

inserting said liner into said pipe by turning said liner inside out.

The method is characterized by further comprising:

arranging a pull band with hooks inside said liner prior to turning said first end portion inside out,

pulling said band while said liner is being inserted into said pipe.

In a preferred embodiment, the method comprises extending the pull band or a pull rope attached to the band along the inside of the pipe until it reaches an exit end of the pipe. Thereby a pull from the exit side of the pipe can be applied during the whole insertion of the liner.

Preferably, the method further comprises attaching the end of the first portion to a pressure tube and applying pressure within said liner. Thereby, the pull from the exit end can be supplemented with a push from the entrance end of the pipe.

In a third aspect of the invention, it related to a liner for lining a pipe, comprising a first side that is at least partly flossy, facing the inside of said liner. The invention is characterized in that it comprises a band extending inside and along substantially the whole length of the liner, said band having hooks that are adapted to attach to the flossy side of said liner.

Preferably, the band has a first and a second side surface, both having hooks. Thereby, the liner will be pulled evenly through the pipe, and it is ensured that the pull band will steer the liner through bends of all directions.

Preferably, the pull band extends along the whole length of the liner, and the pull band has hooks along substantially the whole length. This ensures that the pull band can be used to pull or guide the liner through the whole stretch of pipe to be lined.

The arrangement and method of the invention will now be described in more detail, referring to a preferred embodiment shown in the accompanying drawings, where:

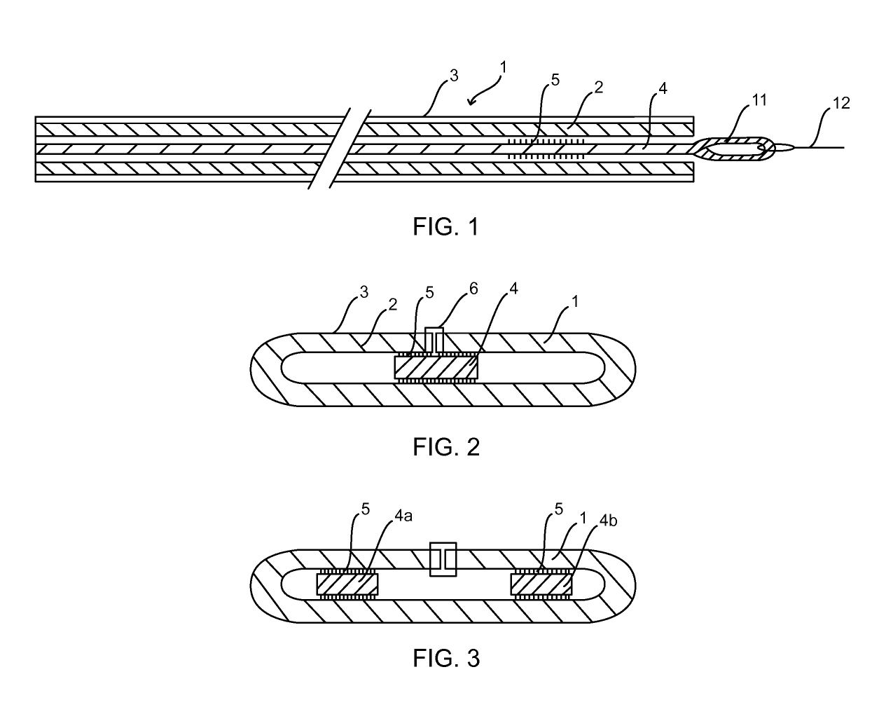

FIG. 1 shows a longitudinal section of a liner according to the present invention,

FIG. 2 shows a cross section of the liner according to the invention, in a first embodiment,

FIG. 3 shows a cross section of the liner according to the invention in a second embodiment,

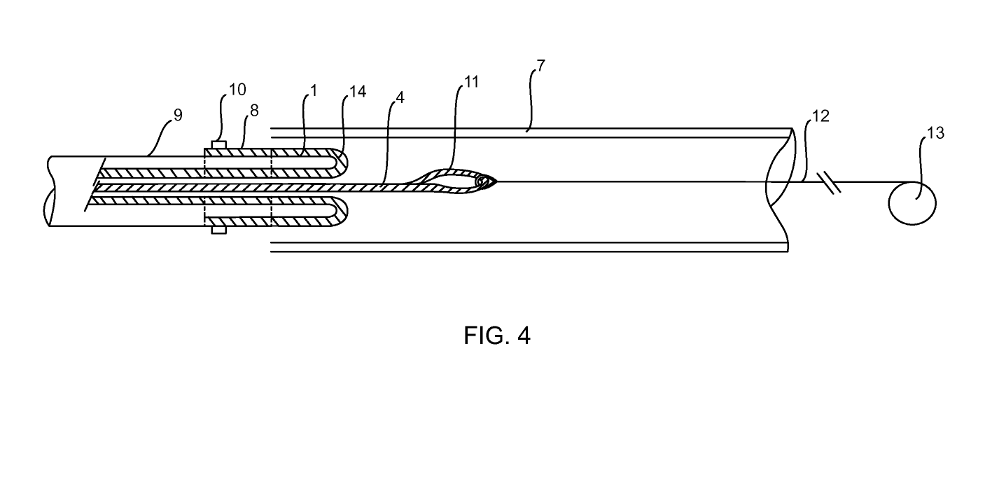

FIG. 4 shows an arrangement according to the invention in a starting phase of the everting,

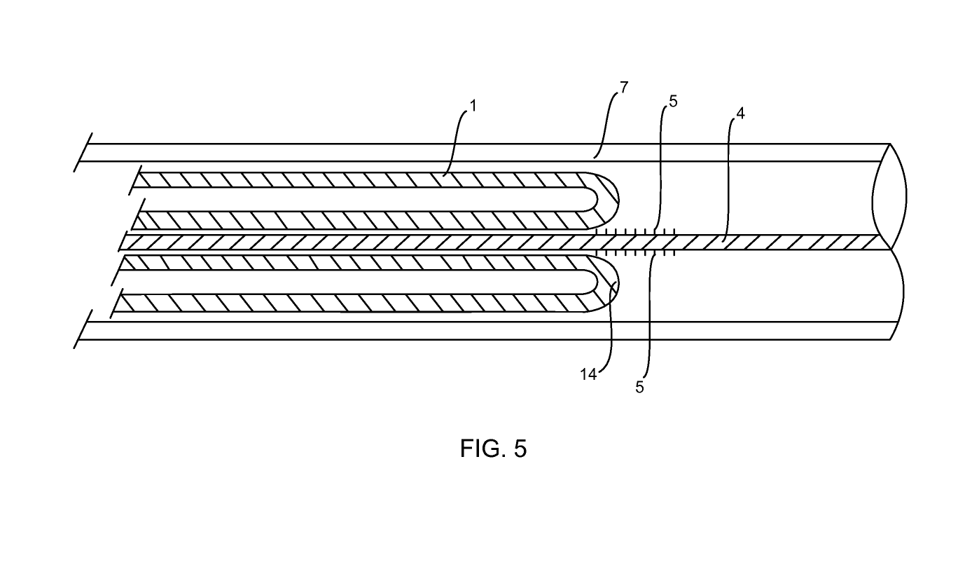

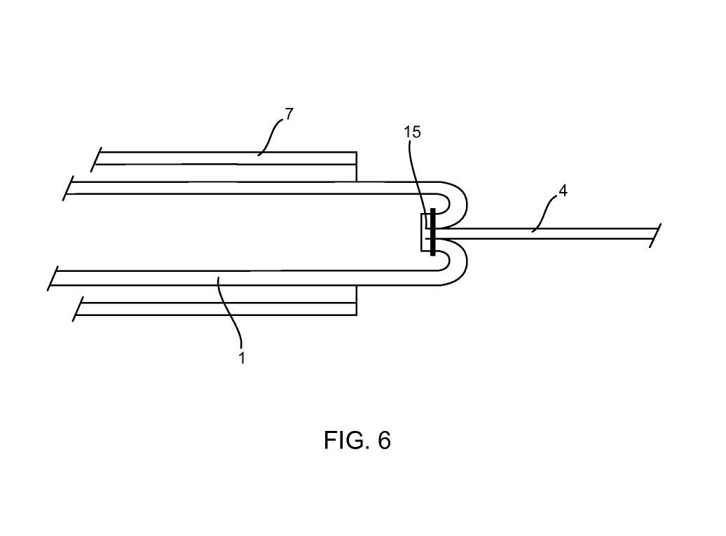

FIG. 5 shows the arrangement of the invention in an intermediate phase of the everting, and

FIG. 6 shows the arrangement of the invention in a final phase of the everting.

It should be noted that the proportions of the drawings may not be to scale and that distances between parts that in reality are lying completely against one another, has been made to better envisage the arrangement.

FIG. 1 shows a generally tube shaped liner 1 according to the invention it comprises at least one layer 2 of felt or similar fabric, which is facing inward of the liner 1. The flossy material may alternatively be a woven or knitted fabric or textile or a roving, such as fibreglass.

At the outwardly facing side of the liner 1 a layer 3 of an impermeable material, such as plastic as been applied. The impermeable coating may be polyurethane, polyethylene, poly vinyl chloride, thermoplastic polyurethane, polypropylene or a material with similar properties.

Inside the liner 1 is situated a band 4 having small hooks 5, preferably made of plastic on one, or preferably both sides. The hooked band may be made by attaching two bands with hooks 5 back to back, so that the hooks face outwards or by folding a band with hooks 5 over itself. The band may be of the Velcro® type or similar. The attachment of the two bands to one another or the folded- over band to itself may be by stitching, adhesive or other fastening methods well-known to the person of skill. Optionally, a tension band, e.g. of a woven fabric, such as materials used for lifting straps or loading straps, may be sandwiched between the hooked bands or folded-over hooked band to provide the composite band with additional tension strength. In the further description the term hooked band or pull band will denote the composite band in all embodiments described above, ranging from a single hooked band with hooks on one side to a tension band with a hooked band on both sides. It should also be noted that the band may be of any cross sectional shape, even circular, as long as there is room for enough hooks on its surface to attach the band to the felt.

The pull band preferably extends along the whole length of the liner, and it has preferably hooks along the whole length.

Due to the flossy felt, the small hooks of the pull band 4 will attach to the inside of the liner 1 as shown in FIG. 1. At one end, the pull band 4 has a loop 11 to which a pull rope 12 may be attached. Alternatively, if the inside of the liner is not of a flossy material, strips of a flossy material or a band having loops may be attached to the inside of the liner.

FIG. 2 shows an embodiment of the liner 1 with one pull band 4. The liner has been made from a long flat sheet of felt with plastic coating on one side. There may also be several sheets of felt material. In this state the pull band 4 is placed on top of the liner sheet at the felt 2 side. Then the liner sheet has been folded into a tube and thereby wrapped around the pull band 4. The edges of the liner sheet has been stitched together by a seam 6 that extends along the length of the liner 1. Alternatively, the edges may also be welded or glued. If there are several sheets of felt material, the individual layers may be stitched together separately. This is a well-known the technique per se. Finally, the liner is pressed flat so that the felt 2 attaches also to the other, i.e. upper side in the figures, of the pull band 4. In this state the liner may be reeled onto a spool for transport. It should be noted that the liner 1 at one end, later denoted trailing or distal end 15 of the liner, will be closed by tying a piece of cord or similar around the end.

FIG. 3 shows an alternative with two pull bands 4a and 4b, extending in parallel along the inside of the liner. This embodiment is particularly useful for large diameter liners. It should be noted that it is also possible to arrange more than two pull bands within the liner. It is also possible to arrange one very broad band.

When the liner is to be installed the inside (felt side) is first soaked in a resinous substance, such as epoxy. The method for doing this is well known in the art and need not be described. It is evident that the area where the pull band 4 is attached to the felt 2, the epoxy may not completely soak the felt 2. However, when the liner 1 has been installed, excess epoxy will float from nearby areas into the areas that have been covered with the pull band 4.

15

FIG. 4 shows the arrangement according to the invention in an initial phase of the everting of the liner 1 into a pipe 7. A first end 8 (which in the following also will be termed proximal end) of the liner 1 has been attached to a pressure tube 9 using a tightening band 10, such as a hose clamp or similar. To facilitate this, a proximal length of the liner 1 has been turned inside out and pulled back a short distance, creating a leading end 14 of the liner, which will extend the furthest into the pipe 7. It should be noted that the rest of the liner extends into the pressure tube 9 to a liner chamber (not shown) where it has been coiled up. This is a well-known technique per se in the art.

A pull rope or wire 12 is attached to the pull band 4. This may be done by tying it to the loop 11 at the leading end of the pull band 4, or alternatively by stitching or gluing the two together. The rope 12 will be blown through the pipe 7 by a per se well-known technique, or by other means extended along the inside of the pipe, until it reaches the exit end of the pipe. Here the rope will be attached to a winch reel 13 or similar pulling device. Alternatively, the pulling may also be done by hand.

Now the pressure tube 9 will be pressurized by air, water or any other suitable fluid. This will force the liner 1 to evert into the pipe 7 by turning itself inside out. At the same time a moderate pull is exerted on the pull rope 12 by the winch 13. The two forces, pressure push and rope/band pulling, will both act to evert the liner into the pipe 7. As the liner 1 is turned inside out at the leading end 14, the leading end 14 will propagate further into the pipe 7, as shown in FIG. 5, where the leading end 14 has propagated some distance into the pipe 7. If the pipe 7 has bends, the pull force will assist in guiding the leading end 14 through the bends. When the liner 1 is turned inside out at the leading end 14 the felt 2 will be pulled away from the pull band 4 in an approximately transverse direction to the band 4. As the force acting to pull the felt 2 transversely away from the band 4 acts on a small portion of the felt at a time, the hooks 5 will not be able to hold on to the felt 2. Consequently, the felt 2 will be pulled away easily from the band 4. The air, or other fluid, pressure inside the liner 1 will push the liner 1 against the inside of the pipe 7 and ensure that the epoxy adheres to the pipe 7.

FIG. 6 shows the final stage of the insertion of the liner 1. The trailing, or distal, end 15 will emerge from the pipe 7. This end may simply be cut off. Hence, the pipe has now been completely lined without the need to expose the pipe between the ends of the pipe 7.

The pull band 4 and pull rope 12 will now be completely soiled by epoxy or similar. Depending on the type of epoxy, it may be possible to clean the band for reuse, but in most cases the band 4 and rope 12 will have to be disposed of.

In some cases it may be possible to omit the use of pressurized fluid for everting the liner, or only a minor pressure to force the liner against the inside of the pipe, especially if the pipe length is short. In such cases, the operation may be done at less cost, using only the pull band 4.

With the techniques according to the invention, it is possible to line a pipe continuously over as much as several hundred meters.

1. An arrangement for inserting a liner into a pipe, the arrangement comprising:
a liner having a first side that is at least partly flossy, said liner being adapted to be everted into the pipe, so that the flossy side is turned from being inside the liner to become the outside of the liner as the liner propagates along the inside of the pipe;
wherein the liner comprises a pull band having hooks on at least one side of said band, said hooks being adapted to attach to said flossy side of said liner.

2. The arrangement of claim 1, wherein the pull band extends along substantially the whole length of the liner, and that the pull band has hooks along substantially the whole length.

3. The arrangement of claim 1, wherein said pull band comprises hooks on two side surfaces of said band.

4. The arrangement of any of claim 1, wherein a pull rope is attached to a leading end of said band.

5. A method for inserting a liner into a pipe, said liner having a first side that is at least partially flossy, the method comprising:
turning a first end portion of said liner inside out;
fixating the end of said first end portion;
entering said first end portion into said pipe;
inserting said liner into said pipe by turning said liner inside out;
arranging a pull band with hooks inside said liner prior to turning said first end portion inside out; and
pulling said band while said liner is being inserted into said pipe.

6. The method of claim 5, comprising extending the pull band or a pull rope attached to the band along the inside of the pipe until it reaches an exit end of the pipe.

7. The method of claim 5, comprising attaching the end of the first portion to a pressure tube and applying pressure within said liner.

8. A liner for lining a pipe, comprising:
a first side that is at least partly flossy, facing the inside of said liner;
wherein the liner comprises a band extending inside and along substantially the whole length of the liner, said band having hooks that are adapted to attach to the flossy side of said liner.

9. The liner of claim 8, wherein said band has a first and a second side surface, both having hooks.

10. The liner of claim 8, wherein the pull band extends along the whole length of the liner, and that the pull band has hooks along substantially the whole length.
